(19) United States
(12) Patent Application Publication
(10) Pub. No.: US 2002/0190221 A1
(43) Pub. Date: Dec. 19, 2002

(54) Electronic test standard for fluorescence detectors

(76) Inventor: James S. Hutchison, Indianapolis, IN (US)

Correspondence Address: C. John Brannon, Woodard, Emhardt, Naughton, Moriarty and McNett, Bank One Center/Tower, 111 Monument Circle, Suite 3700, Indianapolis, IN, 46204-5137, US

(21) Appl. No.: 09/884,771

(22) Filed: Jun. 19, 2001

(51) Int. Cl. G01N 21/64

(52) U.S. Cl. 250/459.1

(57) ABSTRACT

The present invention relates to a self-contained optical repeater that detects light of a first frequency (color) and emits light at a different frequency (color) with intensity related to the incident light flux of the detected light of the first frequency. The emitted light of the second frequency (i.e., the excitation light) is used to fluoresce an optical sample to emit the detected light of the second frequency (i.e., the fluoresced light). The frequency (and energy) of the excitation light greater than the frequency (and energy) of the fluoresced light. The excitation light is filtered and detected by a photodiode. Output of the excitation light is electronically controlled to be a predetermined fraction of the incident fluorescent illumination as filtered and presented to the electronic control circuit in a geometry that mimics a specific fluorescent chemistry. It is important to control the output of the excitation light source to compensate for variations of the light source output with variations in external conditions, such as temperature, to maintain a truly constant ratio between the excitation and fluoresced light intensities.

### TECHNICAL FIELD OF THE INVENTION

The present invention relates generally to fluorimetry and, more particularly, to a novel method and apparatus for using an electronic calibration standard to calibrate a fluorimeter without the use of a physical fluorescence standard.

### BACKGROUND OF THE INVENTION

Fluorimetry is an important quick and nondestructive analytical chemistry technique. Fluorimetry is used to acquire both qualitative and quantitative data, and is of great interest for use in clinical chemistry and medical diagnostics as a means for measuring unknowns such as the pH and partial pressure of blood gasses and blood analytes.

In general, fluorometric analysis involves shining an energetic light onto a sample and stimulating the immediate re-emission or fluorescence of light of a particular frequency from the sample. The frequency of the light so fluoresced is characteristic of the particular sample component fluorescing. The frequency of the light shined onto the sample is usually chosen to be slightly higher than that of the frequency of the light characteristically fluoresced by the sample component desired to be measured. In other words, the fluoresced light has an energy less than or equal to that of the light source, since conservation of energy and the quantum nature of light dictate that, for single photon processes, the fluoresced photons cannot be more energetic than the excitation photons absorbed to produce the fluoresced photons.

Fluorimeters are currently calibrated by fluorescing stable materials having well-known fluorescent wavelengths and well-characterized fluorescent intensities as calibration standards. For a homogeneous sample excited by a light source having a given frequency and intensity, the intensity of the fluoresced light is proportional to the quantity of the fluorescent material. So long as the calibration standard is a suitable simulacrum of the sample to be investigated, the requirement for stability of the light source and optical detection system on the fluorimeter is mitigated by the use of a suitable calibrator in conjunction with the measurement. One important feature of this calibrator is to return to the instrument “fluoresced” photons of the appropriate color and at an intensity substantially proportional to the fluorescence excitation.

Special fluorimeters measure the lifetime of the fluorescent state using pulse and/or phase sensitive techniques. Although these measurements are not directly sensitive to the magnitude of the fluorescent signal, some degree of regularization of signal amplitude is often useful and rudimentary calibration required.

The currently available fluorescent calibration standard materials suffer from a number of serious drawbacks contributing to measurement errors, but have the overarching advantage of being the only options available for calibrating a fluorimeter. Examples of sources of error afflicting fluorescent standards include the relative rarity of fluorescing materials, the instability of most fluorescing materials under ambient environmental conditions, the inability to stabilize organic fluorescent materials through glass encapsulation, variations in fluorescent intensity between different specimens of the same fluorescent material (intrasample variation) and geometrical differences between the source and the detector from calibration to calibration arising due to variances in sample placement. Therefore, a need has arisen for a fluorescence calibration standard with reduced geometric and intrasample variations and having stable fluorescence properties over time and environmental conditions. The present invention addresses this need.

### SUMMARY OF THE INVENTION

The present invention relates to an electrical device for comparing the intensity of the light from a fluorescence excitation source in a fluorimetry instrument to the light emitted from an emulation light source that emulates the light that is otherwise resultingly fluoresced from an optical sample. The electrical device also controls the output of the excitation source to maintain a substantially constant relationship between the intensity of the excitation source and the intensity of the emulation source, and thereby the fluoresced light. The device includes a light source for emulating the fluorescence emission, a first photodetector for measuring the intensity of the excitation light source, a second photodetector for measuring the intensity of the emulated fluorescence, and an electronic circuit for comparing the intensities of the light from the excitation source and the emulation source, and for controlling the intensity of the emulation source to maintain a constant, predetermined ratio between the two that may be used by the instrument for calibration purposes.

One form of the present invention relates to an electronic fluorescence standard, including a window for receiving light from a fluorescence excitation light source in a fluorimetry instrument, a first photodetector, a fluorescence emulation light source, and a first light pipe extending from the excitation light source to the emulation source and to the first photodetector, a second photodetector, a second light pipe extending from the emulation light source to the second photodetector, and an electronic controller operationally connected to the emulation light source, the first photodetector and the second photodetector, wherein the second light pipe is adapted to direct light from the emulation light source to the second photodetector, wherein the first light pipe is adapted to direct light from the excitation light source to the first photodetector, wherein the first and second photodetectors are adapted to respectively send a first and a second output current to the electronic controller proportional to the light received by the respective photodetector, and wherein the electronic controller is adapted to compare the first and the second output currents and adjust the light output of the emulation light source to achieve a predetermined relationship between the first and the second output currents.

One object of the present invention is to provide an improved apparatus for calibrating a fluorimeter. Related objects and advantages of the present invention will be apparent from the following description.

### BRIEF DESCRIPTION OF THE DRAWINGS

FIG. 1 is a schematic illustration of the fluorescence meter calibration device of a first embodiment of the present invention.

FIG. 2 is a schematic illustration of an electronic control circuit in the electronic controller of FIG. 1.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

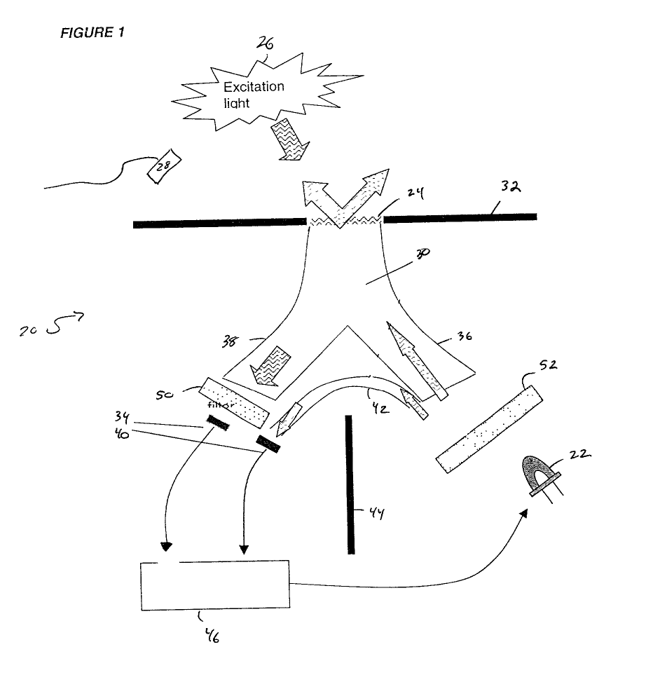

The present invention relates to a method and apparatus for calibrating a fluorimeter. FIG. 1 illustrates one embodiment of the present invention, an electronic fluorimeter calibration device 20 positionable in a fluorimeter. The calibration device 20 is capable of detecting light of a first predetermined color and emitting light of a second, different predetermined color with intensity related to the detected light flux. The calibration device 20 includes a fluorescense emulation light source 22 positioned to shine through an optically transparent window 24 in the calibration device 20 and onto a component of a fluorimetry instrument, such as the fluorescence excitation light source 26 or a calibration photodetecotor 28. The emulation light source 22 is preferably a light-emitting diode (LED), but may be of any convenient design capable of providing light of sufficient energy and frequency to emulate the light characteristic of a desired fluorescence target material. The fluorescence emulation light source 22 is preferably positioned to shine through the window 24 through a light pipe 30 positioned between the emulation light source 22 and the window 24. The light pipe 30 is preferably able to direct light from the emulation source 22 through the window 24 through the process of internal reflection. However, any optical device or system capable of efficiently directing light from the emulation light source 22 to the window 24 may be chosen. More preferably, an opaque optical shield 32 is formed around the window 24 formed therein and is positioned such that light from the emulation light source 22 is guided through the light pipe 30 and through the window 24 to shine onto the calibration photodetector 28. The opaque optical shield 32 thereby substantially prevents extraneous light from shining through the window in either direction and contributing to measurement error. The light pipe 30 may also preferably be configured to guide light from the optical sample excitation source 26 to a first photodetector 34. As illustrated in FIG. 1, the light pipe 30 is preferably generally Y-shaped, with a first leg 36 extending from the emulation light source 22 to the window 24 and a second leg 38 extending from the window 24 to the first photodetector 34. The light pipe 30 may, however, have any convenient shape functional to guide light from the emulation light source 22 to the window 24 and from the window 24 to the first photodetector 34.

A second photodetector 40 is positioned to receive light from the emulation light source 22. Preferably, the light from the emulation light source 22 is guided to the second photodetector 40 by a second light pipe 42, although the second photodetector 40 may be positioned to receive light directly from the emulation light source. As with regards to the first light pipe 30, the second light pipe 42 preferably directs light from the emulation light source 22 to the second photodetector 40 through total internal reflection, but may alternately do so through any other convenient light directing process. More preferably, the emulation light source 22 is shielded from directly shining onto the first and/or the second photodetector 34, 40, such as by the placement of an opaque shield 44 therebetween.

The first and second photodetectors 34, 40 are electrically connected to an electronic controller 46. The electronic controller 46 is also electrically connected to the emulation light source 22. The electronic controller 46 includes circuitry adapted to compare the inputs from the two photodetectors 34, 40 and to change the output of the emulation light source 22 in order to maintain a preselected relationship between the outputs of the two photodetectors 34, 40, and to therefore allow the emulation light source 22 to maintain the frequency and intensity of the fluorescent material it is desired to emulate.

The calibration device 20 is preferably configured as a cartridge, compatible to be plugged into a fluorimeter for calibration as required. However, the calibration device 20 may also be configured as a built-in feature of a fluorimeter. The surface of one or more of the optical elements (i.e., the light pipe(s) 30, 42, the filter 52, the window 24) may be optically textured such that the light from the emulation source 22 more closely resembles the light from the true fluorescent source it emulates. For example, if the emulated fluorescence source is characterized by diffuse emission, a diffuser or diffusing coating may be applied to one or more of the optical elements such that the calibration device 20 more closely emulates the character of the light emitted from the emulated fluorescence source.

In operation, the calibration device 20 functions to simulate the scattering geometry and fluorescence of the chemistries associated with a particular fluorescence meter system. Light from the excitation light source 26 of the fluorimeter is directed to the first photodetector 34. Light from the fluorescence emulation light source is directed to the second photodetector 40 and is sampled thereby. The first and second photodetectors 34, 40 each send a signal to the electronic controller 46 proportional to the intensity of the incident light from the respective light sources 26, 22. The second photodetector 40 is chosen to have its peak frequency sensitivity range coincide with the peak frequency of the light source 22, with photodetectors 40 having different peak frequencies paired with emulation light sources 22 of different peak frequencies to calibrate the fluorimeter for different fluorescent materials. In other words, since a given fluorescent material emits fluorescent light having a characteristic peak frequency, an emulation light source 22/second photodetector 40 pair is chosen to respectively emit and detect light of a frequency matched to that of the fluorescent material for which the fluorimeter is desired to be calibrated. Likewise, the first photodetector 34 is also preferably chosen to have its peak frequency sensitivity range coincident with the peak excition frequency.of the fluorescent materials.

The electronic controller 46 automatically converts the currents from the photodetectors 34, 40 to voltages and compares the voltages. The electronic controller 46 then automatically generates an amplified response voltage, which is then converted to a current to drive the emulation light source 22. The circuit automatically tries to eliminate or substantially minimize the difference in current (or transimpedance amplified voltage outputs) between the signals from the photodetectors 34, 40. This is accomplished by varying the response voltage, and therefore the current driving the emulation light source 22, such that the output of the emulation light source 22 is varied until the signals from the two photodetectros 34, 40 are substantially identical.

The calibration device 20 is therefore a self-contained optical repeater that detects light of a predetermined frequency or color, and emits light of a lower frequency (different, less energetic color) with intensity governed to satisfy a predetermined intensity relationship between the detected light of the first frequency and the emitted light of the second frequency.

The calibration device 20 preferably includes a filter 50 between the light from the excitation source 26 and the first photodetector 34. A emulation source filter 52 is likewise preferably positioned between the emulation source 22 and the second photodetector 40. The efficiency of the filters 50, 52 for reducing the intensity of the light shining therethrough and onto a respective photodetector 34, 40 determines the effective intensity of the light passing therethrough to shine on a respective photodetector 34, 40 and therefore the intensity of the current generated by the respective photodetector 34, 40 to be sent to the electronic controller 46. By properly selecting the efficiency value of the filters 50, 52 the relative intensities of the lights generated by the excitation light source 26 and the emulation source 22 may be controlled. In principle this control could be accomplished via the electronics, but because the emulation intensity may be much smaller (10ˆ -6) than the excitation intensity both optical filters and suitable electronic components can be chosen to produce maximum stability.

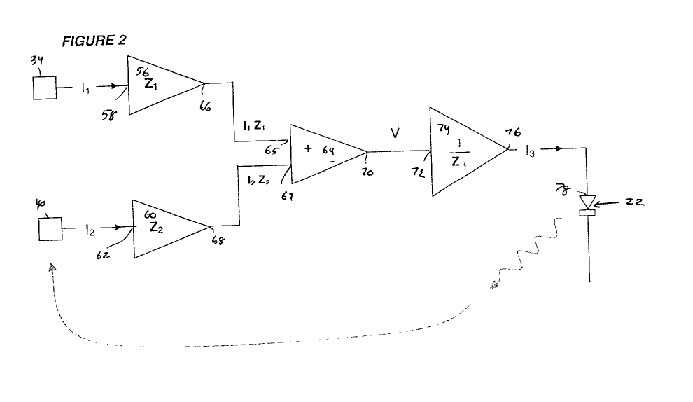

FIG. 2 illustrates one example of an electronic controller 46 circuit design adapted to compare the inputs from the two photodetectors 34, 40 and to change the output of the emulation light source 22 in greater detail. There are many electronic circuit designs capable performing the servometric function, this approach is illustrative of one straightforward method. A first transimpedance amplifier 56 is connected to the first photodetector 34, such that the output current from the first photodetector 34 is received as by the input 58 by the first transimpedance amplifier 56. Likewise, a second transimpedance amplifier 60 is connected to receive the output current from the second photodetector 40 through the second transimpedance amplifier input 62. An operational amplifier 64 is provided having a non-inverting input 65 connected to the output 66 of the first transimpedance amplifier 56 and an inverting input 67 connected to the output 68 of the second transimpedance amplifier 60. The output 70 of the operational amplifier is electrically connected to the input 72 of a transconductance amplifier 74. The output 76 of the transconductance amplifier 74 is electrically connected to the anode 78 of a light-emitting diode 22, the cathode 82 of which is connected to a ground potential.

In operation, a first current I₁ is generated by light incident upon the first photodetector 34. The first current I₁ is proportional to the intensity of the light on the first photodetector 34. Likewise, a second current I₂ is generated by and proportional to light incident upon the second photodetector 40. The current I₁ from the first photodetector is input into the first transimpedance amplifier 56 and transformed into a voltage output having a voltage equivalent to I₁Z₁, where Z₁ is the transimpedance value of the first transimpedance amplifier 56. Similarly, the second transimpedance amplifier 60 (having a transimpedance value of Z₂) outputs a voltage of I₂Z₂ in response to a current input I₂.

The operational amplifier 64 has a gain of G and receives the voltage I₁Z₁ input at the non-inverting terminal 65 and the voltage I₂Z₂ at the inverting terminal 67, and outputs a voltage V in response. The voltage V is the voltage input to the transconductance amplifier 74, which outputs a current I₃ according to the equation

I₃=V/Z₃

where Z₃ is the transconductance value of the transconductance amplifier 74. The current I₃ is then output to the anode 78 of the light emitting diode 22, where it is used to drive the photonic emission of the light-emitting diode 22. In other words, the intensity of the light emitted from the light-emitting diode 22 is proportional to the current I₃ flowing thereinto.

Since the current I₂ flowing from the second photodetector 40 is proportional to the light shining onto the second photodetector 40 from the light-emitting diode 22, and the light emitted from the light-emiting diode 22 is proportional to the current I₃ flowing therethrough, the current I₂ is proportional to the I₃. Therefore,

I₂=αI₃

where α is a proportionality constant. The value of α is a function of the efficiency of the light-emitting diode 22, the efficiency of the transmission of the light from the light-emitting diode 22 to the second photodetector 40, and of the efficiency of the second photodetector 40 in converting light energy to current.

The output voltage V of the operational amplifier 64 may be expressed as

V=G(I₁Z₁−I₂Z₂)

where G is the gain of the operational amplifier 64. Since V=I₃Z₃, by replacement we can arrive at the expression

V=I₂Z₃/α

and therefore

I₂=(Z₁/Z₂)I₁[1+(Z₃/αGZ₂)].

So long as the second bracket term is small, the fluoresced light intensity will be substantially proportional to the excitation light intensity, depending only on the constancy of the transimpedance ratio. This criterion is easily met in practice.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are to be desired to be protected.

What is claimed is:

1. An electronic fluorescence standard, comprising:
a fluorescence emulation light source;
a first photodetector;
a fluorescence excitation light source;
a first light pipe adapted to convey light from the fluorescence excitation light source to the first photodetector;
a second photodetector;
a second light pipe adapted to direct light from the fluorescence emulation light source to the second photodetector; and
an electronic controller operationally connected to the fluorescence emulation light source, to the first photodetector and to the second photodetector;
wherein the first and second photodetectors are adapted to respectively send a first and a second output voltage to the electronic controller proportional to the light received by the respective photodetector; and
wherein the electronic controller is adapted to compare the first and the second output voltages and adjust the light output of the fluorescence emulation light source to achieve a predetermined relationship between the first and the second output voltages.

2. The electronic fluorescence standard of claim 1, further comprising a first optical filter positioned between the excitation light source first photodetector and a second optical filter positioned between the fluorescence emulation light source and the second photodetector.

3. The electronic fluorescence standard of claim 1 wherein the fluorescence emulation light source is a light emitting diode.

4. The electronic fluorescence standard of claim 1 wherein the first photodetector has a first photodetector output, wherein the second photodetector has a second photodetector output, wherein the fluorescence emulation source is a light emitting diode, and wherein the electronic controller further comprises:
a first transimpedance amplifier having a first transimpedance amplifier output and a first transimpedance amplifier input electrically connected to the first photodetector output;
a second transimpedance amplifier having a second transimpedance amplifier output and a second transimpedance amplifier input electrically connected to the second photodetector output;
an operational amplifier having a non-inverting input electrically connected to the first transimpedance amplifier output, an inverting input electrically connected to the second transimpedance amplifier output, and an operational amplifier output; and
a transconductance amplifier having a transconductance amplifier input electrically connected to the operational amplifier output and a transconductance amplifier output;
wherein the light-emitting diode has an anode electrically connected to the transconductance amplifier output and a cathode electrically connected to a ground potential; and
wherein the light emitting diode is adapted to shine at least a portion of the light emitted therefrom onto the second photodetector.

5. The electronic fluorescence standard of claim 4 wherein the output voltages of the first and second transimpedance amplifiers are maintained to be substantially identical.

6. The electronic fluorescence standard of claim 1, wherein the electronic controller further is adapted to maintain a substantially constant ratio between the output of the excitation light source and the input of the first photodetector.

7. A fluorescence standard device, comprising:
an internal light source having an inupu and an output;
a window adapted to transmit light from an external light source;
a first photodetector in photonic communication through the window;
a second photodetector in photonic communication with the internal light source; and
an electronic controller in electric communication with the first and second photodetectors and the internal light source input;
wherein the electronic controller is adapted to receive electric communications from the first and second photodetectors proportional to light respectively incident thereon; and
wherein the electronic controller is adapted to compare the electric communications from the first and second photodetectors and servo the output of the internal light source until a predetermined relationship between the electric communications from the first and second photodetectors has been achieved.

8. The device of claim 7, wherein light source is filtered.

9. The device of claim 7 further comprising light generated by the internal light source and wherein the electronic controller further is adapted to maintain a substantially constant ratio between light generated by the internal light source and the electric communications from the first photodetector.

10. The device of claim 7 wherein the first photodetector has a first photodetector output, wherein the second photodetector has a second photodetector output, wherein the internal light source is a light emitting diode, and wherein the electronic controller further comprises:
a first transimpedance amplifier having a first transimpedance amplifier output and a first transimpedance amplifier input electrically connected to the first photodetector output;
a second transimpedance amplifier having a second transimpedance amplifier output and a second transimpedance amplifier input electrically connected to the second photodetector output;
an operational amplifier having a non-inverting input electrically connected to the first transimpedance amplifier output, an inverting input electrically connected to the second transimpedance amplifier output, and an operational amplifier output; and
a transconductance amplifier having a transconductance amplifier input electrically connected to the operational amplifier output and a transconductance amplifier output;
wherein the light-emitting diode has an anode electrically connected to the transconductance amplifier output and a cathode electrically connected to a ground potential; and
wherein the light emitting diode is adapted to shine at least a portion of the light emitted therefrom onto the second photodetector.

11. The device of claim 7 wherein the electric communication from the first photodetector is a first current, wherein the electric communication from the second photodetector is a second current, wherein the output of the first transimpedance amplifier is a first voltage, wherein the output of the second transimpedance amplifier is a second voltage, and wherein the operational amplifier output drives the transconductance amplifier to drive the light source to produce a second output current from the second photodetector such that the input voltages to the operational amplifier are substantially equal.

12. A method of electronically calibrating a fluorimeter having an excitation light source, a fluorescence emulation light source, a first and a second photodetector, and an electronic controller operationally connected to the photodetectors and the light source, comprising the steps of:
a) actuating the excitation light source to shine onto the first photodetector;
b) generating a first signal from the first photodetector proportional to the intensity of the light shining thereupon from the excitation light source;
c) shining light from the fluorescence emulation light source onto the second photodetector;
d) generating a second signal from the second photodetector proportional to the light shining thereupon;
e) comparing the relationship of the first signal relative to the second signal to a predetermined value; and
f) changing the output of the fluorescence emulation light source such that the relationship of the first signal relative to the second signal substantially matches the predetermined value.

13. An electrical circuit for calibrating the output of a fluorimeter, comprising:
a first photodetector having an first photodetector output;
a second photodetector having an second photodetector output;
a first transimpedance amplifier having a first transimpedance amplifier output and a first transimpedance amplifier input electrically connected to the first photodetector output;
a second transimpedance amplifier having a second transimpedance amplifier output and a second transimpedance amplifier input electrically connected to the second photodetector output;
an operational amplifier having a non-inverting input electrically connected to the first transimpedance amplifier output, an inverting input electrically connected to the second transimpedance amplifier output, and an operational amplifier output;
a transconductance amplifier having a transconductance amplifier input electrically connected to the operational amplifier output and a transconductance amplifier output;
a light-emitting diode having an anode electrically connected to the transconductance amplifier output and a cathode electrically connected to a ground potential;
wherein the light emitting diode is adapted to shine at least a portion of the light emitted therefrom onto the second photodetector.

14. The circuit of claim 11 further including an excitation light source adapted to shine onto the first photodetector.

15. The circuit of claim 12 wherein the first transimpedance amplifier outputs a voltage proportional to the light falling onto the first photodetector and wherein the second transimpedance amplifier outputs a voltage proportional to the light falling on the second photodetector.

16. The circuit of claim 13 wherein the light emitting diode output is used as feedback to drive the voltage outputs of the first and second transimpedance amplifiers to substantially the same value, such that a ratio of the output of the light emitting diode and the input of the first photodetector is substantially constant.
